(19) United States
(12) Patent Application Publication
(10) Pub. No.: US 2011/0089707 A1
(43) Pub. Date: Apr. 21, 2011

(54) ENERGY ABSORBER FOR A VEHICLE BUMPER ASSEMBLY

(75) Inventors: Francesc Perarnau Ramos, Sabadell (Barcelona) (ES); Lluis Puit Cases, Manresa (Barcelona) (ES); Julio Peidro Aparici, Barcelona (ES)

(73) Assignee: AUTOTECH ENGINEERING, A.I.E., Abadiano (Bizkaia) (ES)

(21) Appl. No.: 12/674,695

(22) PCT Filed: Aug. 30, 2007
(86) PCT No.: PCT/ES07/00501

§ 371 Date: Feb. 23, 2010

(51) Int. Cl. B60R 19/26

(52) U.S. Cl. 293/132

(57) ABSTRACT

The invention relates to an energy absorber for a vehicle bumper assembly, comprising a thrust transmitting section (1) and a deformable section (2) which are connected to one another, the respective opposing ends thereof being connected to a bumper cross-member (3) and a longitudinal member (4) of a main structure of the vehicle. The thrust transmitting section (1) includes a thrust transmitting member (5) having an elongate configuration extending along the longitudinal axis of the vehicle. The deformable section (2) includes: deformable members (6, 8) in the form of a bridge defining stacked and joined supporting configurations (6a, 8a) to which the thrust transmitting member (5) is connected, and legs (6b) which extend from said supporting configurations (6a, 8a) substantially along the longitudinal axis of the vehicle and which are connected to the longitudinal member (4), optionally by means of a flat bar (10). The energy absorber is housed inside the longitudinal member upon deformation of the deformable section (2).

### TECHNICAL FIELD

The present invention generally relates to an energy absorber for a vehicle bumper assembly, and more particularly to a high-performance energy absorber configured to provide a very high level of energy absorbed per millimeter of deformation in comparison with the performance of other absorbers of the prior art.

### BACKGROUND OF THE INVENTION

Patent GB-A-884953 describes an energy absorber comprising a tube of a ductile metal, such as aluminium or copper, each end of which is connected to one and the other of a pair of thrust transmitting members, such that a relative movement of the thrust transmitting members in the axial direction of the tube bends the tube inside out over at least part of its length. In an embodiment, the tube of ductile metal is connected at one end to a longitudinal member of the main structure of a vehicle and at the other end to a rigid tube acting as a thrust member connected in turn to a bumper cross-member of the vehicle. The tube of ductile metal has a supporting configuration and a configuration favorable for deformation at the end connected with the rigid tube. Once deformed, the tube of ductile metal can be housed together with part of the rigid tube in a hollow interior of the longitudinal member of the main structure of the vehicle, thus taking advantage of all or most of the potential deformation run of the tube of ductile metal.

A drawback of the absorber of the mentioned patent GB-A-884953 is that the ductile metal of which the deformable tube is made can be too soft to absorb large amounts of energy, and in addition, manufacturing the deformable tube with a cylindrical shape and with said supporting configuration and configuration favorable for deformation from an ultra-high-strength steel could be complicated and expensive.

### DISCLOSURE OF THE INVENTION

The present invention contributes to solving the previous and other drawbacks by providing an energy absorber for a vehicle bumper assembly, of the type comprising a thrust transmitting section and a deformable section connected to one another, where said thrust transmitting section and said deformable section have respective opposite ends connected to a bumper cross-member of said bumper assembly of said vehicle and to a longitudinal member of a main structure of the vehicle, respectively, such that a relative movement of said bumper cross-member towards said longitudinal member is transmitted by the thrust transmitting section to the deformable section to cause a deformation thereof. The energy absorber of the present invention is characterized in that said thrust transmitting section comprises at least one thrust transmitting member having an elongated configuration in the longitudinal direction of the vehicle and said deformable section comprises at least one first deformable member in the form of a bridge defining a first supporting configuration to which said thrust transmitting member is connected and at least two first legs which extend from said first supporting configuration substantially in the longitudinal direction of the vehicle.

In a preferred embodiment, the deformable section comprises two deformable members in the form of a bridge defining respective supporting configurations connected to one another and respective pairs of legs which extend from opposite sides of the respective supporting configurations, substantially in the longitudinal direction of the vehicle, and where the two deformable members are crossed such that the four legs extend from the four sides of a quadrilateral formed by the respective superimposed supporting configurations. Each of the legs preferably has a deformation configuration for facilitating the deformation thereof.

According to an embodiment, the four legs of the deformable members have ends connected to a plate fixed to the end of the longitudinal member of the main structure of the vehicle, which has a hollow interior. The mentioned plate has an opening located between the legs of the deformable members, facing said hollow interior of the longitudinal member of the main structure of the vehicle and sized to allow the passage of the thrust transmitting section and the deformable section to the hollow interior of the longitudinal member. Thus, the thrust transmitting section and the deformable section can be housed in the hollow interior of the longitudinal member of the main structure of the vehicle when the deformable section is deformed in the longitudinal direction of the vehicle. By making the length of the thrust transmitting member substantially equal to or greater than the deformation run of the four legs of the deformable members, maximum advantage is taken of the energy absorption potential of the deformable section, since virtually the material in the entire length of the legs is subjected to deformation during the deformation run when the legs are completely deformed as a consequence of a force in the longitudinal direction of the vehicle.

In another embodiment, the four legs of the deformable members have ends directly connected to walls of the longitudinal member of the main structure of the vehicle around said hollow interior of the longitudinal member, such that the thrust transmitting section and the deformable section can likewise access the hollow interior of the longitudinal member when the deformable section is deformed in the longitudinal direction of the vehicle.

The construction of the deformable section by means of two crossed deformable members in the form of a bridge allows each deformable member to be obtained from a sheet metal element shaped by one or more of the typical sheet shaping processes, such as cutting, die cutting, bending, press forming and deep drawing, among others. The deformable members are preferably made of an ultra-high-strength steel (UHSS), for example, with an elastic limit stress from 600 to 1000 MPa and a breaking point stress between 800 and 1500 MPa, and with a thickness from 2 to 5 mm, shaped by progressive press forming in a die. The thrust transmitting member, which has a lower commitment, can be made, for example, from a cut-to-length extruded tube of medium steel with an elastic limit stress of about 300 MPa. Thus, the deformable members, the thrust transmitting member and optionally the plate can furthermore be attached by welding.

With this construction, an energy absorber is achieved which is provided with a very long deformation run, as a result of the capacity to be housed inside the hollow interior of the longitudinal member of the structure of the vehicle, and capable of providing a very high level of energy absorbed per length of deformation as a result of the high elastic limit of the deformable members, in comparison with the efficiency of other absorbers of the prior art.

### BRIEF DESCRIPTION OF THE DRAWINGS

The previous and other features and advantages will be more fully understood from the following detailed description of several embodiments with reference to the attached drawings, in which:

FIG. 1 is a perspective view of an energy absorber according to a first embodiment of the present invention installed in a vehicle bumper assembly;

FIGS. 2 and 3 are perspective views of deformable members forming part of the energy absorber of FIG. 1;

FIG. 4 is a perspective view of a thrust transmitting member forming part of the energy absorber of FIG. 1;

FIG. 5 is a perspective view of a plate forming part of the energy absorber of FIG. 1;

FIG. 6 is a perspective view of the components of FIGS. 2 to 5 assembled in a commercial presentation form of the energy absorber of FIG. 1;

FIG. 7 is a schematic side view of an energy absorber of the present invention installed in a vehicle bumper assembly in a situation prior to colliding with an obstacle;

FIG. 8 is a schematic side view of the energy absorber of FIG. 7 during the collision with an obstacle;

FIG. 9 is a partially sectioned schematic side view of the energy absorber of FIG. 7 in a situation after the collision with an obstacle;

FIG. 10 is a perspective view of a deformable member similar to that of FIG. 3 incorporating holes and notches for controlling the level of energy absorbed;

FIG. 11 is a perspective view of an energy absorber according to a second embodiment of the present invention; and

FIG. 12 is a perspective view of an energy absorber according to a third embodiment of the present invention.

### DETAILED DESCRIPTION OF EXEMPLARY EMBODIMENTS

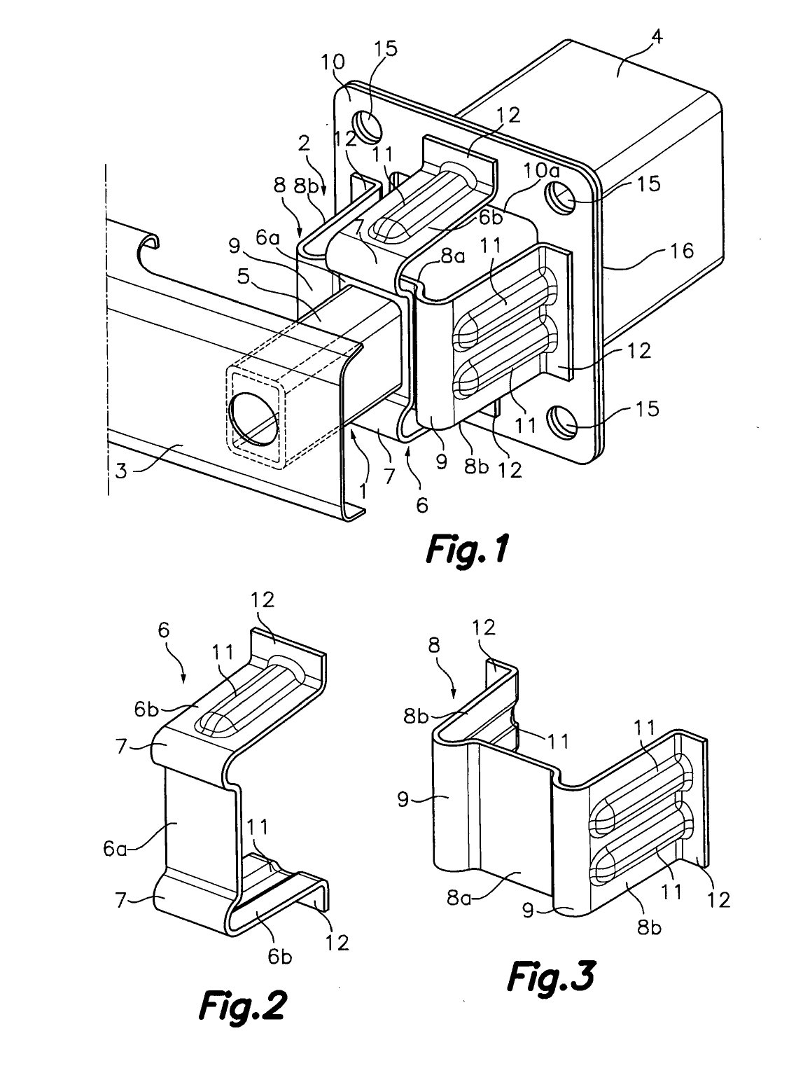

With reference first to FIGS. 1 to 6, an energy absorber for a vehicle bumper assembly according to a first embodiment of the present invention is described below, which comprises a thrust transmitting section 1 and a deformable section 2 connected to one another. The thrust transmitting section 1 has an end opposite to the deformable section 2 connected to a bumper cross-member 3 of the bumper assembly of the vehicle and the deformable section 2 has an end opposite to the thrust transmitting section 1 connected to a longitudinal member 4 of a main structure of the vehicle. Thus, in the event of a collision, a relative movement of the bumper cross-member 3 towards the longitudinal member 4 is transmitted by the thrust transmitting section 1 to the deformable section 2 causing a deformation thereof. The deformation of the deformable section 2 is capable of absorbing a large amount of the energy generated in the collision.

In this first embodiment, the thrust transmitting section 1 is formed by a thrust transmitting member 5 having an elongated configuration in the longitudinal direction of the vehicle, such as, for example, a segment of metal tube shown separately in FIG. 4, and said deformable section 2 is made up of first and second deformable members 6, 8 in the form of a bridge shown separately in FIGS. 2 and 3, respectively, which are obtained from sheet metal elements. The mentioned first deformable member 6 (FIG. 2) defines a first supporting configuration 6a to which the thrust transmitting member 5 is connected and two first legs 6b arranged substantially in the longitudinal direction of the vehicle extend from opposite sides of said first supporting configuration 6a. Similarly, the second deformable member 8 (FIG. 3) defines a second supporting configuration 8a connected to the first supporting configuration 6a of said first deformable member 6 and two second legs 8b which extend from opposite sides of said second supporting configuration 8a substantially in the longitudinal direction of the vehicle. When the energy absorber is assembled, as shown in FIG. 6, the first and second deformable members 6, 8 are crossed such that the two first legs 6b and the two second legs 8b extend from the four sides of a quadrilateral formed by the first and second superimposed supporting configurations 6a, 8a. Each of said first legs 6b has at least one first deformation configuration 7 for facilitating the deformation thereof and each of said second legs 8b has at least one second deformation configuration 9 for facilitating the deformation thereof, and furthermore, the two first legs 6b and the two second legs 8b are slightly inclined in directions diverging from their respective first and second supporting configurations 6a, 8a.

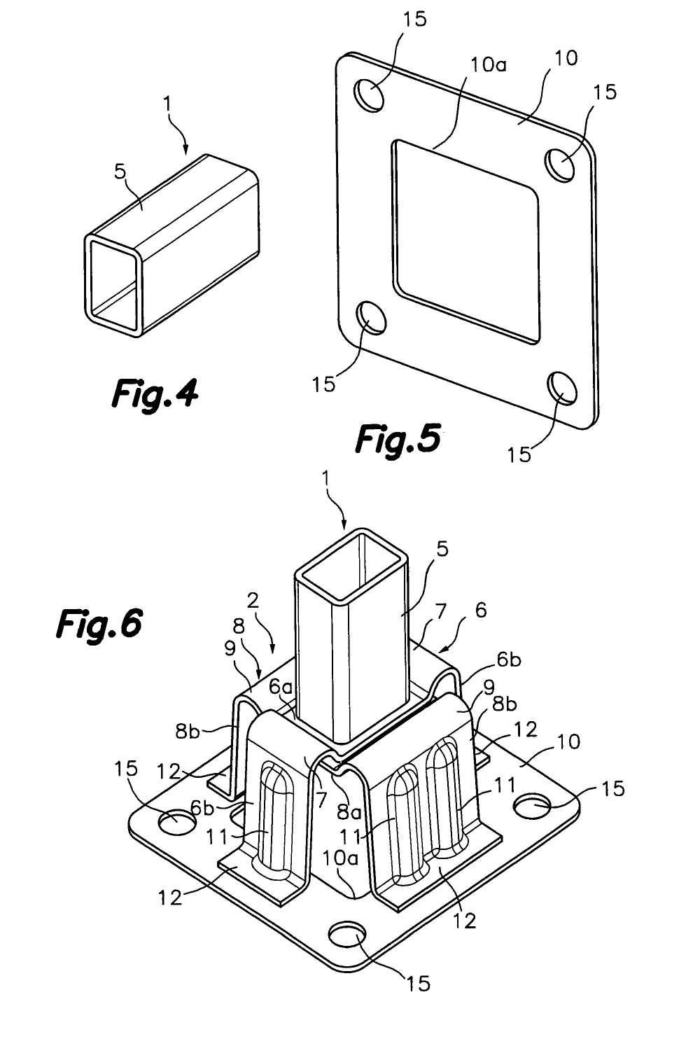

In the end farthest from the corresponding first or second supporting configuration 6a, 8a, each of the first and second legs 6b, 8b has formed therein a flange 12 bent in a direction transverse to the longitudinal direction of the vehicle, and said flanges 12 are attached to a plate 10, shown separately in FIG. 5, which is likewise obtained from a sheet metal element. The mentioned plate 10 has a substantially square or rectangular configuration and is provided with an opening 10a in a central part, which is located between the first and second legs 6b, 8b of the first and second deformable members 6, 8 when the energy absorber is assembled, and holes 15 close to the corners. The attachments between the thrust transmitting member 5, the first and second deformable members 6, 8 and the plate 10 are obtained by welding to obtain the commercial presentation form of the energy absorber of the first embodiment of the present invention shown in FIG. 6.

As shown in FIG. 1, the longitudinal member 4 of the main structure of the vehicle has a hollow interior, and a structure plate 16 having a central opening facing said hollow interior and peripheral holes is fixed at the end of the longitudinal member 4. In an operative situation such as the one shown in FIG. 1, the holes 15 of the plate 10 of the energy absorber are aligned with the holes of the structure plate 16 such that screw and nut assemblies (not shown) can be installed therethrough to fix the energy absorber to the longitudinal member 4, and the mentioned opening 10a of the plate 10 of the energy absorber is in coincidence with the opening of the structure plate 16 and in communication with the hollow interior of the longitudinal member 4. Furthermore, the opening 10a of the plate 10 and the opening of the structure plate 16 are sized to allow the passage of the thrust transmitting section 1 and the deformable section 2, whereby the thrust transmitting section 1 and the deformable section 2 of the energy absorber can pass through the opening 10a of the plate 10 and be progressively housed in the hollow interior of the longitudinal member 4 when the deformable section 2 is deformed in the longitudinal direction of the vehicle.

The first and second deformable members 6, 8 include several configurations which contribute to determining with relative precision the level of energy absorbed by the deformable members and the level of energy which is transmitted to the longitudinal member 4 of the main structure of the vehicle. Firstly, these configurations comprise the mentioned first and second deformation configurations 7, 9 formed in the first and second deformable members 6, 8, each of which comprises an arched portion between the corresponding first or second supporting configuration 6a, 8a and the corresponding first or second leg 6b, 8b. The radii of these deformation configurations 7, 9, as well as the remaining deep drawing radii, are defined to contribute to determining the direction of the deformation, the stress transmitted to the longitudinal member 4 and the level of energy absorbed. Furthermore, the first and second legs 6b, 8b include embossed ribs 11 arranged in the longitudinal direction of the vehicle. The size, amount, arrangement and depth of these ribs 11 are selected to contribute to determining the level of energy absorbed. The thickness and the type of material used in first and second deformable members 6, 8 also contributes to determining the behavior characteristics thereof. By way of example, the first and second deformable members 6, 8 can be made from ultra-high-strength sheet metal elements, for example, with an elastic limit stress from 600 to 1000 MPa, and with a thickness from 2 to 5 mm, and can be shaped by progressive press forming in a die. In contrast, the thrust transmitting member 5, given its lower commitment, can be made from a cut-to-length extruded tube of medium steel with an elastic limit stress of about 300 MPa which makes it a low-cost component.

FIG. 10 shows a variant of the second deformable member 8 incorporating holes 13 in the legs 8b and notches 14 formed in the side edges of the legs 8b. The number, size and configuration of these holes 13 and notches 14 are selected to contribute to determining the stress transmitted to the longitudinal member 4 and the level of energy absorbed. The holes 13 and notches 14 are optional and compatible with the first and second deformation configurations 7, 9 and with the ribs 11, as well as with other additional configurations, such as cuts.

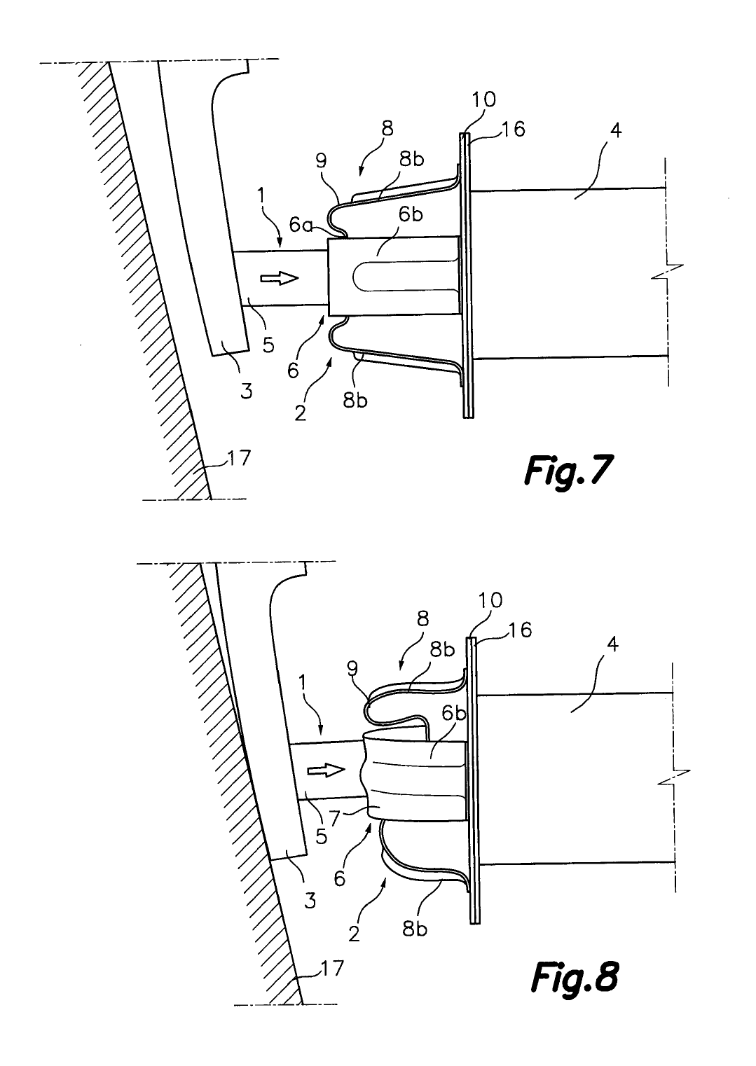

FIGS. 7, 8 and 9 show a sequence of views schematically showing an energy absorber of the present invention installed in an operative situation in a vehicle bumper system before, during and after a collision.

In FIG. 7, the energy absorber is connected to the bumper cross-member 3 and to the longitudinal member 4 of the main structure of the vehicle, and the bumper cross-member 3 is at a distance from an obstacle 17.

In FIG. 8, the bumper cross-member 3 has collided with the obstacle 17 and a relative movement of the bumper cross-member 3 with respect to the longitudinal member 4 of the main structure of the vehicle is occurring, and the force of the impact is transmitted by the thrust transmitting member 5 to the first and second deformable members 6, 8, which are being deformed and thus absorb part of the energy produced in the collision.

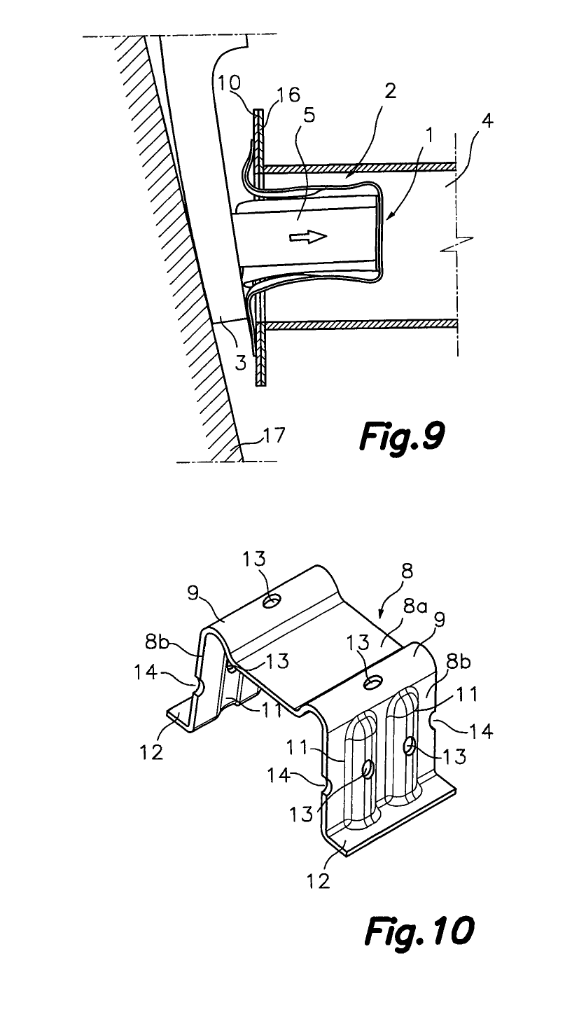

In FIG. 9, the first and second deformable members 6, 8 are completely deformed and have been driven by the thrust transmitting member 5 to the hollow interior of the longitudinal member 4 of the main structure of the vehicle. It should be observed that the length of the thrust transmitting member 5 is substantially equal to or greater than the deformation run of the two first and second legs 6b, 8b of the first and second deformable members 6, 8 when such legs are completely deformed as a consequence of the force of the impact in the longitudinal direction of the vehicle. Thus, during the impact the energy absorber of the present invention takes advantage of substantially the entire potential deformation run of the first and second deformable members 6, 8 such that substantially all the points of the first and second deformable members 6, 8 have been deformed, therefore the energy absorber of the present invention provides a high efficiency.

FIG. 11 shows an energy absorber according to a second embodiment of the present invention, which is completely similar to the energy absorber of the first embodiment described in relation to FIGS. 1 to 6 except in that here the first and second legs 6b, 8b of the first and second deformable members 6, 8 do not end in bent flanges but rather they have ends farther from the corresponding first and second supporting configuration 6a, 8a arranged in the longitudinal direction of the vehicle and are attached by butt-joint to the plate 10 by welding.

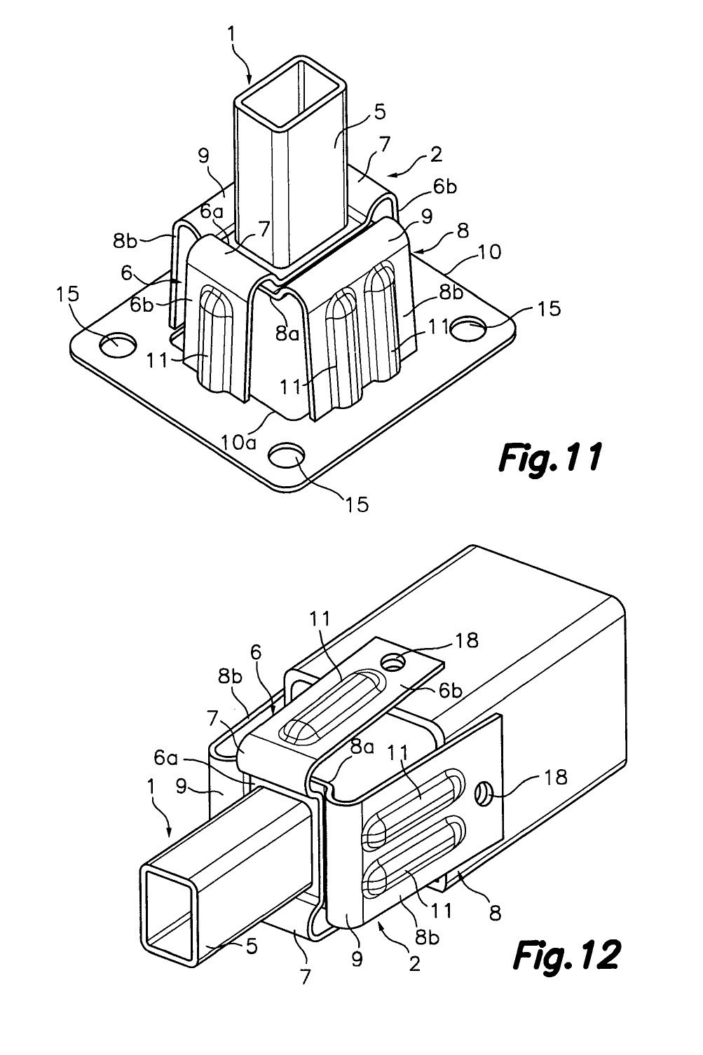

FIG. 12 shows an energy absorber according to a third embodiment of the present invention, which is completely similar to the energy absorber of the first embodiment described in relation to FIGS. 1 to 6 except in that here the plate 10 has been dispensed with, and the first and second legs 6b, 8b of the first and second deformable members 6, 8 do not end in bent flanges but rather they have flat ends connected directly to walls of the longitudinal member 4 of the main structure of the vehicle arranged around said hollow interior of the longitudinal member 4. Thus, an opening in the end of the longitudinal member 4 allows the passage of the thrust transmitting section 1 and the deformable section 2 to the hollow interior of the longitudinal member 4. At the mentioned flat ends of the first and second legs 6b, 8b of the first and second deformable members 6, 8 there are formed holes 18 which in an operative situation are aligned with corresponding holes formed in the walls of the longitudinal member 4, such that screw and nut assemblies (not shown) can be installed through said holes to fix the energy absorber to the longitudinal member 4. FIG. 12 shows the flat ends of the first and second legs 6b, 8b of the first and second deformable members 6, 8 arranged at the outer part of the longitudinal member 4 of the main structure of the vehicle. However, in an embodiment variant, not shown, the flat ends could be arranged at the inner part of the longitudinal member 4 with an equivalent result. In this third embodiment of the present invention, the commercial presentation of the energy absorber would only include the thrust transmitting member 5 and the first and second deformable members 6, 8 attached to one another.

In the previous embodiments, the first deformable member 6 is narrower than the second deformable member 8 and has a different number of ribs, however, it will be understood that both the first and second deformable members 6, 8 could be substantially identical, with only a slight difference in the length of the legs 6b, 8b to make up for the thickness of the sheet in the superimposed supporting configurations 6a, 8a. Likewise, although the thrust transmitting member 5 is shown as a tube with a substantially rectangular cross-section, it will be understood that it could have any other cross-section, such as square, polygonal, circular, etc.

Although in all the embodiments described and shown the deformable section 2 of the energy absorber is made up of two crossed deformable members 6, 8 having two legs 6b, 8b each, an energy absorber with a single deformable member provided with two or more legs would also fall within the field of the present invention. Likewise, an energy absorber with a deformable section made up of two or more deformable members, each having more than two legs or other combinations would also fall within the field of the present invention. In addition, although it is preferred that the deformable members 6, 8 are configured to be obtained from sheet steel elements shaped by press forming or deep drawing, the present invention is not limited thereto and the deformable members 6, 8 could be made in any other way which meets the requirements provided in the attached claims. Likewise, the deformation configurations 7, 9, the ribs 11, the holes 13 and the notches 14 are optional and can be combined with one another in variable number, shapes and sizes. The thrust transmitting portion 5 does not indispensably have to have a tubular shape and can have any other configuration providing sufficient rigidity.

A person skilled in the art will be able to carry out modifications and variations from the embodiments shown and described without departing from the scope of the present invention as it is defined in the attached claims.

1.-22. (canceled)

23. An energy absorber for a vehicle bumper assembly, comprising a thrust transmitting section and a deformable section connected to one another, wherein said thrust transmitting section and said deformable section have respective opposite ends connected to a bumper cross-member of said bumper assembly of said vehicle and to a longitudinal member of a main structure of the vehicle, respectively, such that a relative movement of said bumper cross-member towards said longitudinal member is transmitted by the thrust transmitting section to the deformable section to cause a deformation thereof, said thrust transmitting section comprises at least one thrust transmitting member having an elongated configuration in the longitudinal direction of the vehicle and said deformable section comprises a first deformable member in the form of a bridge defining a first supporting configuration to which said thrust transmitting member is connected and at least two first legs which extend from said first supporting configuration substantially in the longitudinal direction of the vehicle, and a second deformable member in the form of a bridge defining a second supporting configuration connected to the first supporting configuration of said first deformable member and at least two second legs which extend from said second supporting configuration substantially in the longitudinal direction of the vehicle, wherein said first and second deformable members are crossed such that the two first legs and the two second legs extend from the four sides of a quadrilateral formed by the first and second superimposed supporting configurations.

24. The absorber according to claim 23, wherein each of said first legs has at least one first deformation configuration for facilitating the deformation thereof and each of said second legs has at least one second deformation configuration for facilitating the deformation thereof.

25. The absorber according to claim 24, wherein the first deformable member has two first legs which extend from opposite sides of the first supporting configuration and the second deformable member has two second legs which extend from opposite sides of the second supporting configuration.

26. The absorber according to claim 25, wherein the two first legs and the two second legs are slightly inclined in directions diverging from their respective first and second supporting configurations.

27. The absorber according to claim 23, wherein the thrust transmitting section and the deformable section are configured to be housed in a hollow interior of the longitudinal member of the main structure of the vehicle when the deformable section is deformed in the longitudinal direction of the vehicle.

28. The absorber according to claim 27, wherein the length of the thrust transmitting member is substantially equal to or greater than the deformation run of the two first and second legs of the first and second deformable members when they are completely deformed as a consequence of a force in the longitudinal direction of the vehicle.

29. The absorber according to claim 27, wherein the first and second legs of the first and second deformable members have ends connected to a plate fixed to the end of the longitudinal member of the main structure of the vehicle, said plate having an opening located between the first and second legs of the first and second deformable members, facing said hollow interior of the longitudinal member of the main structure of the vehicle and sized to allow the passage of the thrust transmitting section and the deformable section to the hollow interior of the longitudinal member.

30. The absorber according to claim 27, wherein the first and second legs of the first and second deformable members have ends connected directly to walls of the longitudinal member of the main structure of the vehicle arranged around said hollow interior of the longitudinal member to allow the passage of the thrust transmitting section and the deformable section to the hollow interior of the longitudinal member.

31. The absorber according to claim 27, wherein the first and second deformable members comprise respective first and second deformation configurations each comprising an arched portion between the corresponding first or second supporting configuration and the corresponding first or second leg, said arched portion being configured to contribute to determining the direction of the deformation, the stress transmitted to the longitudinal member and the level of energy absorbed.

32. The absorber according to claim 27, wherein at least one of the first and second legs includes at least one rib in the longitudinal direction of the vehicle configured to contribute to determining the level of energy absorbed.

33. The absorber according to claim 27, wherein at least one of the first and second legs includes at least one hole and/or a cut and/or a notch configured to contribute to determining the stress transmitted to the longitudinal member and the level of energy absorbed.

34. The absorber according to claim 29, wherein each of the first and second legs includes in its end farthest from the corresponding first or second supporting configuration a flange bent in a direction transverse to the longitudinal direction of the vehicle for attachment to the plate.

35. The absorber according to claim 29, wherein each of the first and second legs has an end farther from the corresponding first or second supporting configuration arranged in the longitudinal direction of the vehicle for attachment by butt joint to the plate.

36. The absorber according to claim 25, wherein each of the first and second deformable members is configured to be obtained from a sheet metal element shaped by one or more sheet metal shaping processes selected from a group including cutting, die cutting, bending, press forming and deep drawing, among others.

37. The absorber according to claim 23, wherein the thrust transmitting member is configured to be obtained from a metal tubular element.

38. The absorber according to claim 34, wherein the first and second legs of the first and second deformable members are attached to the plate by welding.

39. The absorber according to claim 30, wherein the first and second legs of the first and second deformable members are attached to the longitudinal member of the main structure of the vehicle by screwing.

40. The absorber according to claim 25, wherein the thrust transmitting member and the first and second deformable members are made of a metal material and are attached by welding.

41. The absorber according to claim 23, wherein the thrust transmitting member is formed from a cut-to-length extruded tube of medium steel with an elastic limit stress of about 300 MPa.

42. The absorber according to claim 23, wherein the first and second deformable members are ultra-high-strength sheet steel elements with an elastic limit stress from 600 to 1000 MPa and with a thickness from 2 to 5 mm shaped by progressive press forming in a die.

43. The absorber according to claim 35, wherein the first and second legs of the first and second deformable members are attached to the plate by welding.
